(19) United States
(12) Patent Application Publication
(10) Pub. No.: US 2016/0345065 A1
(43) Pub. Date: Nov. 24, 2016

(54) METHOD AND APPARATUS FOR PRESENTING INFORMATION TO A USER

(71) Applicant: Jawanth Vytheeswaran, Plano, TX (US)

(72) Inventor: Jawanth Vytheeswaran, Plano, TX (US)

(21) Appl. No.: 15/160,966

(22) Filed: May 20, 2016

Related U.S. Application Data
(60) Provisional application No. 62/165,043, filed on May 21, 2015.

(51) Int. Cl. H04N 21/462; H04N 21/81; H04N 21/24; H04N 21/2668; H04N 21/458; H04N 7/00; H04N 21/45

(52) U.S. Cl. CPC H04N 21/4622; H04N 7/002; H04N 21/812; H04N 21/4532; H04N 21/2668; H04N 21/458; H04N 21/24

(57) ABSTRACT

Techniques are described for providing a service to user of an output or display device to control screen time, such as on behalf of advertisers. The techniques include providing a service to switch to a second input source/port during switching times, wherein the user is watching content through the display device's first input source/port at the time of switch. The system is configurable to switching rental times, specify additional conditions for a switching to take place including specifying acceptable ad tags and minimum acceptable compensation.

### CROSS-REFERENCE TO RELATED APPLICATIONS

This application claims the benefit of U.S. Provisional Patent Application No. 62/165,043, titled “Method and Apparatus for Presenting Information to a User,” filed May 21, 2015, which is incorporated by reference herein in its entirety.

### TECHNICAL FIELD

The present disclosure relates generally to providing information to a user, and more specifically to presenting advertisement to a user.

### BACKGROUND

Users of live or real-time television programming, such as sports are usually served advertisements by the content provider on the same source input to the TV, through which the content is served. Typically, content providers choose the time and content of advertisements to be served. Users who do not wish to see said advertisement have to either manually switch to a different channel on the content provider source or select another source input of their TV, especially when content corresponds to a real-time event such as sports.

### BRIEF SUMMARY

Through applied effort, ingenuity, and innovation, solutions to improve content provider systems have been realized and are described herein. Some embodiments may include method for providing an information selection service by a server connected with an input selection device via a network, the input selection device connected with a first input of the display device, a second input of the display device connected with a content provider device, an output of the display device configured to be selected from the input selection device via the first input or the content provider device via the second input, the method including, by the server: determining a switching period defining a period of time when output of the display device is selected from the input selection device via the first input; detecting an arrival of the switching period while the output of the display device is selected from the content provider device via the second input; and in response to detecting the arrival of the switching period, sending a trigger to the input selection device via the network to initiate the switching period such that the output of the display device switches from the second input connected with the content provider device to the first input connected with the input selection.

In some embodiments, the method may further include, by the server: determining a plurality of parameters corresponding to user preferences received from the input selection device via the network; selecting one or more sources of information according to the user preferences; and subsequent to sending the trigger to the input selection device, providing the one or more sources of information to the input selection device via the network to facilitate output of the one or more sources of information on display device via the first input when the switching period is initiated.

In some embodiments, the plurality of parameters comprise one or more time intervals during which information can be presented to the user. In some embodiments, the one or more sources of information comprise one or more advertisements. In some embodiments, the plurality of parameters comprise: one or more preferred advertisement tags that are used to select the one or more advertisements. In some embodiments, the plurality of parameters comprise: one or more compensation values corresponding to each viewed advertisement.

In some embodiments, the method may further include generating accounting information corresponding to the one or more advertisements provided to the output of the display device during the switching period.

In some embodiments, the method may further include, in response to detecting arrival of the switching period, and by the server: determining whether the display device is in an ON state; and sending the trigger to the input device in response to determining that the display device is in the ON state.

In some embodiments, the method may further include, by the server: detecting an end of the switching period while the output of the display device is selected from the input selection device via the first input; and in response to detecting the end of the switching period, sending a second trigger to the input selection device to end the switching period.

In some embodiments, the display device may be a television.

In some embodiments, the arrival of the switching period may correspond with an arrival of a commercial period within content provided from the content provider device via the second input and an end of the switching period may correspond with an end of the commercial period within the content.

Some embodiments may include a a system for providing an information selection service by a server connected with an input selection device via a network, the input selection device connected with a first input of the display device, a second input of the display device connected with a content provider device, an output of the display device configured to be selected from the input selection device via the first input or the content provider device via the second input, the system comprising: the server configured to: determine a switching period defining a period of time when output of the display device is selected from the input selection device via the first input; detect an arrival of the switching period while the output of the display device is selected from the content provider device via the second input; and in response to detecting the arrival of the switching period, send a trigger to the input selection device via the network to initiate the switching period such that the output of the display device switches from the second input connected with the content provider device to the first input connected with the input selection.

In some embodiments, the server is further configured to: determine a plurality of parameters corresponding to user preferences received from the input selection device via the network; select one or more sources of information according to the user preferences; and subsequent to sending the trigger to the input selection device, provide the one or more sources of information to the input selection device via the network to facilitate output of the one or more sources of information on display device via the first input when the switching period is initiated.

In some embodiments, the plurality of parameters may include one or more time intervals during which information can be presented to the user. In some embodiments, the one or more sources of information comprise one or more advertisements. In some embodiments, the plurality of parameters comprise: one or more preferred advertisement tags that are used to select the one or more advertisements. In some embodiments, the plurality of parameters may comprise: one or more compensation values corresponding to each viewed advertisement.

In some embodiments, the server may be further configured to generate accounting information corresponding to the one or more advertisements provided to the output of the display device during the switching period.

In some embodiments, the server may be further configured to, in response to detecting arrival of the switching period: determine whether the display device is in an ON state; and send the trigger to the input device in response to determining that the display device is in the ON state.

In some embodiments, the server is further configured to: detect an end of the switching period while the output of the display device is selected from the input selection device via the first input; and in response to detecting the end of the switching period, send a second trigger to the input selection device to end the switching period.

In some embodiments, the display device may be a television.

In some embodiments, the arrival of the switching period may correspond with an arrival of a commercial period within content provided from the content provider device via the second input and an end of the switching period may correspond with an end of the commercial period within the content.

### BRIEF DESCRIPTION OF THE DRAWINGS

An understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example high level block diagram of an input selection system, according to one embodiment of the present invention.

FIG. 2 illustrates example operations that may be performed by an input selection device, according to one embodiment of the present invention.

FIG. 3 illustrates example operations that may be performed by server, according to one embodiment of the present invention.

FIG. 4 illustrates further functionality of input selection device, according to one embodiment of the present invention.

FIG. 5 illustrates further functionality of input selection device, according to one embodiment of the present invention.

FIG. 6 illustrates a user interface, according to one embodiment of the present invention.

### DETAILED DESCRIPTION

Embodiments presented herein provide a method and system for switching between input sources of a viewing device in response to server-based triggers. In one embodiment, the viewing device is a television. In one embodiment, one or more of the input sources are advertisement sources. One embodiment, enables a user to rent out screen time to advertisers on a television on its second input source/port while viewing some content through its first input source/port. The system is configurable to specify rental times, acceptable advertisement specified by tags that can be shown during the rental times and minimal acceptable compensation for using the rental times for showing such advertisements. In one embodiment, the user is compensated for the rental time and accounting is maintained of the total time actually rented and corresponding user identification. In one embodiment, the rent or compensation offered to user can be determined by a dynamic auction process.

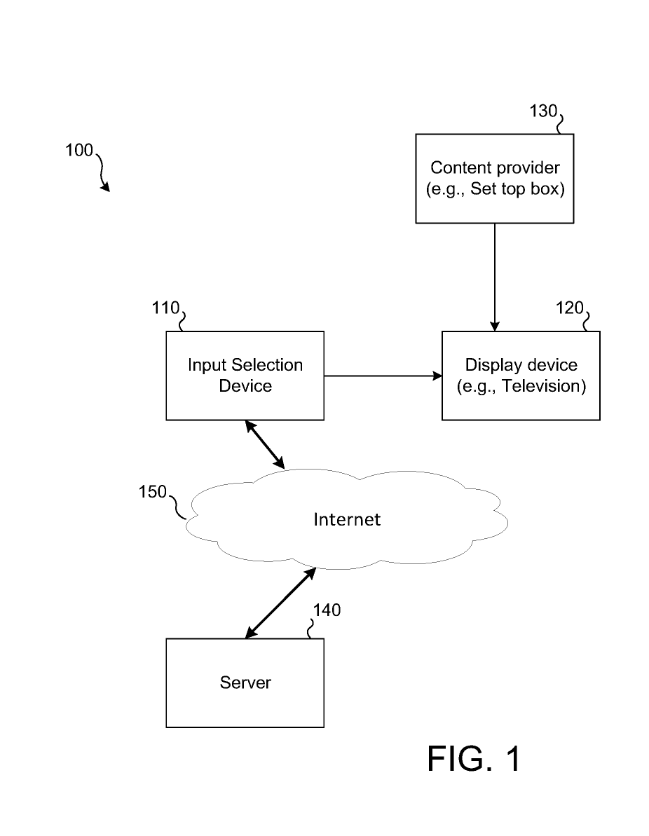

FIG. 1 illustrates an example high level block diagram of an input selection system, according to one embodiment of the present invention. As illustrated, an input selection system may include an input selection device 110, a display device 120, a content providing device 130, and a server 140. The input selection device 110 may interact with the server through internet 150 (i.e., a network), or any other wired and/or wireless communication method. The input selection device may include one or more of processors, CPUs, GPUs, RAM, disk memory, and the like. In addition, the input selection device may interact with one or more input devices such as a keyboard, a mouse or any other input devices.

In a typical arrangement, a display device 120 (e.g., a television) is connected to the input selection device 110. In general, the display device may be connected to the input selection device 110 through a wire or through wireless means. In one embodiment, the display device is connected to receive content from an external content providing device 130. For example, content providing device 130 may be a set-top box or a streaming device, or any other device capable of providing content to the display device. The content for example could be a live telecast of a network broadcast show. The content providing device 130 could be connected to the display device through an input port, or any other means. In one embodiment, the content provider device may be connected to the display device through an HDMI cable. In other embodiments, the content provider device may be connected to the display device through wireless HDMI, or any other wireless mechanism. In general, the input selection device 110 and/or the content providing device 130 may be connected to the display device through HDMI ports, universal serial bus (USB) ports, or any other means (e.g., wired or wireless).

In one embodiment, the content providing device 130 may be a part of the display device (not shown). For example, the content providing device may be an internal software program and/or applications executing on the display device 120, such as those found in smart TV applications. The content providing device streams content received through wired and/or wireless and/or over the air broadcast antennae connection of the display device 120 to the user.

In one embodiment, display device 120 is configured to for the selection of the input sources/ports, individually, by means of remote control and/or a software based control such as HDMI consumer electronic control (CEC) supported by the display device 120. Such smart televisions are commonly available in the marketplace. CEC commands can be issued from input selection device 110 to make display device receive input from specific HDMI ports as stated in the command. For example, input selection device 110 may be configured to issue commands using libCEC, an enabling platform for the CEC bus in HDMI. For example, a command “82” may be issued from the input selection device 110 to the display device 120 on the HDMI wire (or wireless connection), to make the input selection the active source for display device 120. Similarly, for example, to switch to the input source connected with the content provider device 130, which may be connected to an HDMI port 2 of display device 120, the input selection device 110 can issue a command such as “2F:82:20:00”.

In one embodiment, input selection device 110 provides advertisement to the display device to be presented to the user. In another embodiment, the input selection device 110 provides other sources of inputs (e.g., websites, outputs from software applications executing on the selection device 110, or remotely such as at the server 140 or some other server, or the like) to the user. The input selection device 110 may interact with a server 140 through internet 150. In some embodiments, the functionality of the input selection device 110 and the content providing device 130 can reside in the same physical device.

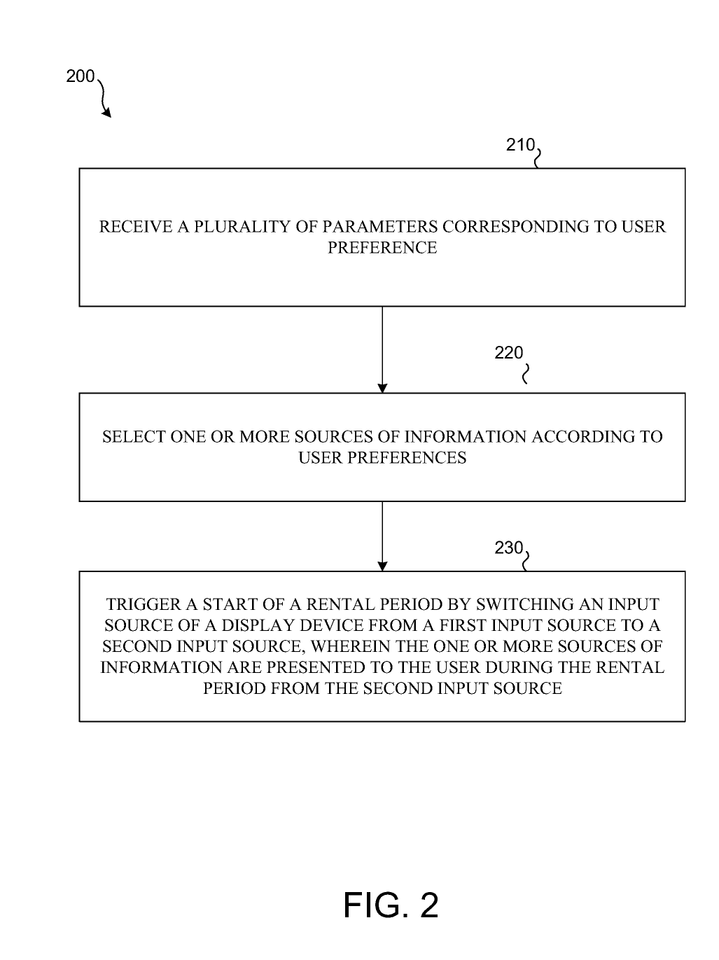

FIG. 2 illustrates example operations that may be performed by an input selection device, according to one embodiment. It should be noted that the input selection device 110 may be used to select any kind of information sources without departing from the teachings of the present disclosure. In general, input sources may include advertisements, software applications, websites and/or any other sources of information. The input selection device may be configured to provide for the unbundling of advertisement content from the content provided by various content provider devices 130.

At 210, the input selection device receives a one or more parameters corresponding to user preference. In general, the one or more of parameters may include one or more time intervals during which inputs (e.g., advertisements) can be presented to the user, one or more preferred advertisement tags, one or more compensation values corresponding to each viewed advertisement, etc. The inputs received may also include the channel identifier (e.g., CNN) or the program the user is presently watching on first input source. The user can invoke Step 210 anytime to change these inputs accordingly.

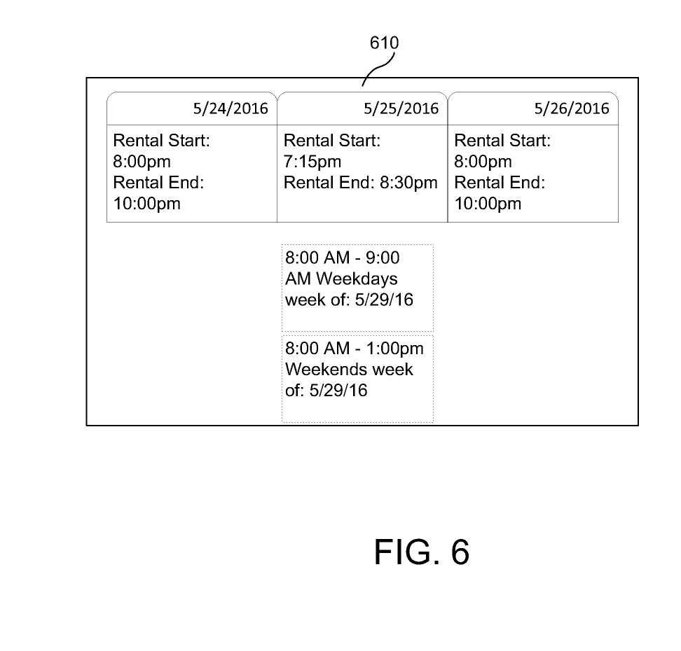

FIG. 6 further illustrates an example user interface, according to some embodiments. Interface 610 shows an example of specifying times when the user is willing to see ads or other content sources served on the display device 120 via the input selection device 110. These times can be filled by user through via input selection device 110 (e.g., an application), web based forms (e.g., via a web service provided by the server 140), etc. Buttons, shortcuts, or other interface components can be provided in the interface 610 to facilitate user specifications or definitions, such as repeatable switching periods (e.g., “every Monday”, or “weekdays” etc). Within these time intervals or switching periods, the user may also allow the input selection device 110 to programmatically serve ads or alternate content sources.

The server 140 has the option to avail of the rental times according to the server's choosing. So some intervals can be skipped with no ads being shown to the user even though user was willing to rent during that interval. For example, if the user has specified “Weekdays 6 pm to 9 pm”, ads may be served for example from 6:21 pm to 6:23 pm, no ads between 6:23 to 6:35 pm, and ads between 6:40 pm-6:43 pm and so on.

In order to pick specific rental times to serve ads, in one embodiment, the server 140 uses one or more timetables provided by third party, of commercial times on television broadcast networks. Alternately, 140 can pick these rental times based on notification of start and end of commercials from agents. One example of an agent includes a human being an individual watching a broadcast on a channel say CNN can signal to 140 that a commercial has started The server then uses that instant as the start of rental time. Continuing this example, the agent can signal to 140 the end of commercials and resumption of programming, The server then uses that instant as the end of rental time.

In another example, the server 140 can use notifications from other third party agents who can send notifications to server 140 of start and end of commercial events.

Input selection device 110 can be used to collect and store the user inputs and specifications or preferences. In one embodiment, during a setup process executed by input selection device 110, input screens corresponding to different selections are presented to the user through display device 120, or other suitably configured user input means. In a typical flow of operation, the user starts to input the values for the multitude of parameters by following prompts and graphical inputs generated by input selection device 110 and displayed on display device 120.

In one example, the user selects time intervals when the user would like to rent out their screen. For example, a time interval could be “6 pm-9 pm on weekdays”. Other examples include but not limited to “18:01:30 to 18:02:00 Sunday 10/21/2014”, “18:10:00-18:12:00 on weekdays”. In general, time interval can be any length of time. One or more or the selected time intervals can overlap. In some embodiments, the user can accept the rental at arbitrary times as determined by the device 110 or Server 140.

The user may also select or specify one or more ad tags that are acceptable. The tags can be expressed as <field, value>pairs joined by Boolean conditions. A set of field values, example, “name” & “location” are provided to user as available advertisement tags. For example, the user can input such things as, but not limited to: name={‘Italian restaurant’}. Another example for illustration is, name={‘car dealerships’} and location={‘Plano, Texas’}. The advertisements in the inventory store of server 140 may have one or more same named fields with corresponding values and thus a selection of ads from the inventory of ads can be made by server 140 based on well know matching methods. In some embodiments, the location used for content selection may be programmatically determined, such as based on Internet Protocol (IP) address, global positioning systems (GPS), etc. for the input selection device 110.

As another parameter, in one example, the input selection device receives one or more inputs from user for specifying the minimum (e.g., zero or more) rental compensation they would accept at a rental interval and/or for specific ad tags, if a rental takes place.

In some embodiments, the user may choose to accept default selections made for them by input selection device 110. In some embodiments, the viewer can also set up the inputs through web browsers from other computers or from input selection device 110, by accessing the server 140. When a user has allowed the default selections to be made by input selection device 110, such default selections (e.g., ad tags to be served) can be generated by server 140, such as depending on availability of ads.

In one embodiment, the input selection device selects and serves ads only if ads meeting or exceeding the user specifications are found in server 140. For example, the user may select “0.25$, tag=“car dealers”, “06:00:00 pm-10:00:00 pm weekdays”; this would lead to zero or more ads being served between those times, if and only if, server 140 has ads in its inventory with tag=“car dealers” and “compensation” equaling 0.25$ or more.

The user can also accept any configuration provided and/or suggested by input selection device 110 instead of having to input any of the values. The user can change the values corresponding to his preferences at any time and the change would be remembered and take effect from then on. The user also has the option to let input selection device 110 change those values at pre-determined times of user's own choosing. The user does not have to do this each time after a setup, since prior values selected are remembered by input selection device 110. Information about user preferences are gathered, stored and/or forwarded to server 140. Any or all of user input preferences are communicated to a server 140.

Referring back to FIG. 2, at 220, the input selection device selects one or more advertisements according to user preferences. At 230, the input selection device triggers a start of a rental period (or “switching period”) by switching an input source of a display device from a first input source to a second input source. The one or more advertisement are presented to the user during the switching period from the second input source.

In one embodiment, the input selection device determines if the television is in ON state and triggers the start of the rental period if the television is in ON state. This is achieved by using, for example, libCEC, an enabling platform for the CEC bus in HDMI. For example, a predefined command (e.g., “8F”) may be issued from the input selection device 110 to the display device 120 on the HDMI wire, to make the input selection device 110 the active source for the display device 120. The input selection device 110 may be configured to parse the returned data using the libCEC HDMI guidelines, to determine the power status (e.g., “on” or “off”) of the display device 120. Other HDMI software commands or monitoring techniques, may be used to accomplish this without departing from the teachings of the present disclosure.

In one embodiment, input selection device 110 triggers an end of the rental or switching period when a first time duration is passed after the start of the rental period. For example, the input selection device 110 switches the input to the first input source when the end of the rental period is reached. Synchronization between a switching period and a commercial period may be achieved in various ways. For example, a human agent may monitor a channel and specify switching times. In another example, the content or channel may include “cues” or other indications of a commercial period, which may be synchronized with a switching period.

In one embodiment, the input selection device 110 or server 140 generates accounting information corresponding to the one or more advertisements that are served during the rental period. The user also has the ability to cut short the rental at any time by issuing commands to 110 and manually changing the input source of the display device 120, such as to an input other than the input selection device 110. In such a situation, a notification of a premature or unexpected switching event may be sent to the server 140 from the input selection device 110.

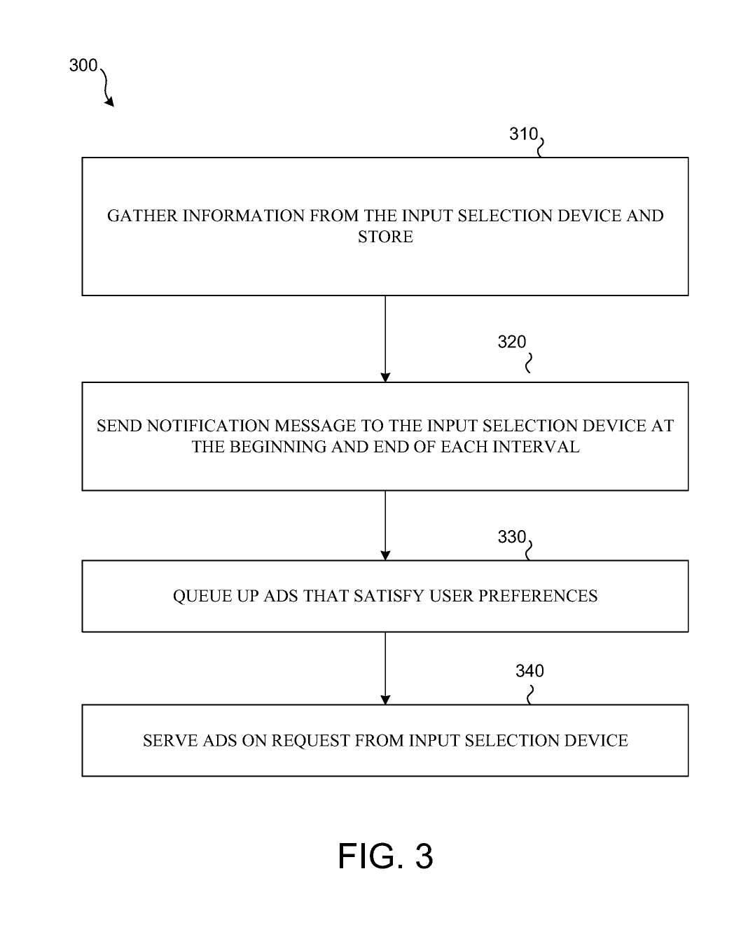

FIG. 3 illustrates example operations that may be performed by server 140. The server may be configured to provide for the unbundling of advertisement content from the content provided by various content provider devices 130, such as via interfacing with and controlling the input selection device 110 connected with the server 140 via the network 150. At 310, server 140 receives information gathered by input selection device 110, or determines some or all of the information using programmatic analysis as discussed herein, and stores it. The server 140 checks when and if the selected time triggers are met and sends a notification to input selection device 110. As such, the server 140 may be configured to determine a switching period defining a period of time when output of the display or display device 120 is selected from the input selection device via a first input, detect an arrival of the switching period while the output of the display device 120 is selected from the content provider device 130 via the second input, and in response to detecting the arrival of the switching period, send a trigger to the input selection device 110 via the network 150 to initiate the switching period such that the output of the display device 120 switches from the second input connected with the content provider device 130 to the first input connected with the input selection 110. The server 140 may be further configured to detect an end of the switching period while the output of the display device is selected from the input selection device via the first input; and in response to detecting the end of the switching period, send a second trigger to the input selection device 110 to end the switching period. In an alternate embodiment, the server receives an input from another device when the selected triggers are met. In another embodiment, the server may send start or stop triggers in accordance with a time table of its own choosing. Server 140 generates notification to input selection device 110 at the start and end of each rental time interval.

Server 140 or input selection device 110 can also keep a set of intervals and default values for users for any of the inputs corresponding to user preferences. In one embodiment, server 140 optionally collects information for the user, from providers of such information, about timing of start and end of commercial breaks in the content served by the content providing device 130. Server 140 can then detect and trigger a start or end of switching period to input selection device 110 coincident with these timings, in Step 320. In another example, such as for live content, a manual operator may view the content concurrently with the broadcast by the content provider device 130 to the display device 120 to control synchronization via detection of the beginning and end of commercial periods. In another example, programmatic machine learning techniques may be applied to the (e.g., streaming) content to programmatically discover the commercial periods. In yet another example, predefined queues or tags within the content may be used to programmatically determine the beginning and end of commercial periods.

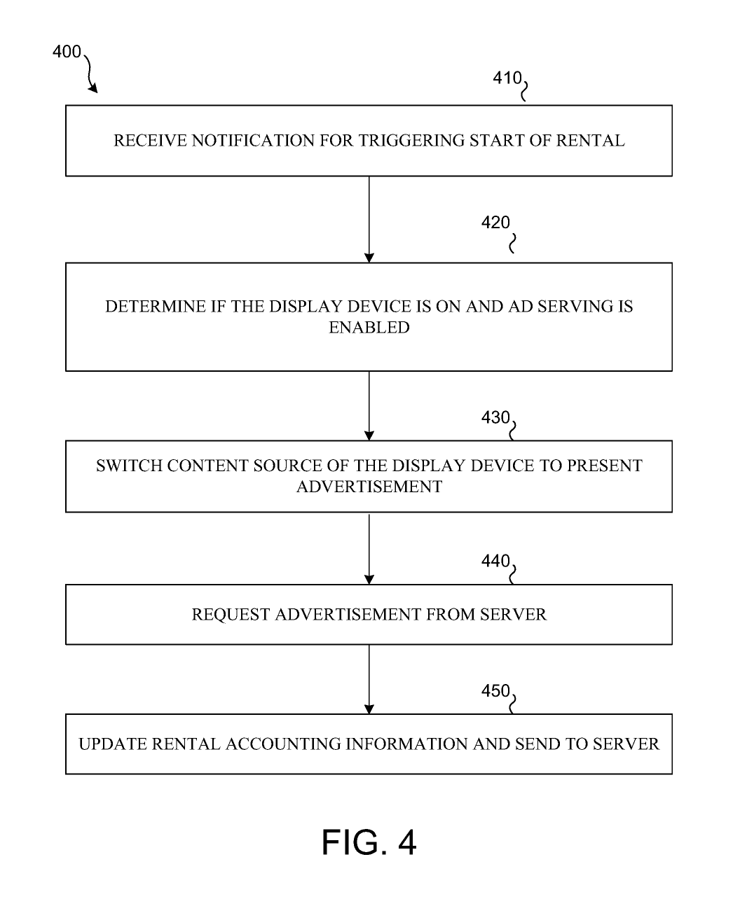

As such, arrival of the switching period may correspond with an arrival of a commercial period within content provided from the content provider device 130 via the second input and an end of the switching period may correspond with an end of the commercial period within the content. The trigger is received by input selection device 110 in step 410 in FIG. 4. In order to serve ads on request from input selection device 110, server 140 also has access to repository of advertisements either stored in server 140 or elsewhere. Other embodiments may implement one or more of the functionality of server 140 in input selection device 110. As such, the server 140 may be configured to, subsequent to sending the trigger to the input selection device 110, provide one or more sources of information to the input selection device 110 via the network 150 to facilitate output of the one or more sources of information on the display device 120 via the first input when the switching period is initiated.

Server 140 checks its inventory of ads in Step 330 to see if one or more advertisements are available that allows for compensation to user of at least the minimal amount as specified by the user. If one or more ad exists, the server informs input selection device 110. Input selection device 110 then requests server 140 to serve the ad in Step 340.

FIG. 4 illustrates further functionality of input selection device 110 to implement methods specifically pertaining to switching of input source/port at the start of a rental time, starting serving of ad, and updating of rental information. Input selection device 110 receives notification in step 410 from server 140. It uses the notification in procedures implementing methods in accordance with the embodiments of present invention.

When input selection device 110 receives a trigger for the start of the rental from server 140, at 430, the input selection device 110 checks if the TV 120 is in the ON state (i.e. TV ON is True). For example, the input selection device 110 may be configured to periodically (e.g., every 10 seconds) attempt to detect if the TV is on or off (or is in idle inactive mode). This is achieved by using, for example, libCEC, an enabling platform for the CEC bus in HDMI. For example command “8F” issued from 110 to 120 on the HDMI wire, returns data that 110 can interpret conclusively using the libCEC HDMI guidelines, the power status (“on” or “off”) of the display device 120. The display device on/off status may be further communicated to the server 140, such as when the server 140 is configured to control the switching. Most modern TV go to inactive/idle state, and the input selection device 110 or server 140 may be configured to sense this inactive/idle state. The input selection device 110 also checks if user has enabled or disabled ad serving (i.e. ad serving enabled is True). If both conditions are True, it selects second input port, causing a switch from the first content source (e.g., from content provider 130) to the second content source (e.g., from the input selection device 110), causing content from second input source to display on the display device 120. In one example, display device 120 is configured to provide for the selection of input sources/ports, individually, by means of remote control and/or a software based control such as HDMI Consumer Electronic Control (CEC) supported by display device 120. An example of a command, for example issued through a UNIX system interface supporting the libCEC interface running in device 110, to switch the input source of the device 110 may include “echo ‘as’ |/usr/bin/cec-client- s.” In another example, the command may include a selection of a specific input source rather than a switch command, such as when more than two input terminals are available on the device 120.

As a next step to 430, input selection device 110 requests the start of ad serving from server 140 using 440. The ad stream is then sent to display 120. The ad stream can be for example an mpeg-4 stream. For example, the ad stream may be sent to the output of the display via the Internet and the input selection device 110. If no ad exists that satisfies any of the preferences and/or compensation criteria, server 140 will notify input selection device 110 accordingly, which will cause input selection device 110 to record that no rental took place, and the rental or switching period effectively ends.

In another embodiment, the procedure 440 is not executed and instead input selection device 110 executes the steps to check if ads exist in its own local file storage. In yet another embodiment, input selection device 110 may access a link, for example an internet site, and stream content from there.

At 450, input selection device 110 also updates rental accounting information, comprising of user id information, content related information, time of day etc. Input selection device 110 also keeps track of any user intervention to stop the source 110 as the source for 120, for example, where the user manually switches the source for 120 to any other source of their choice before the rental time interval has finished. The rental accounting information includes noting such partial viewing 110 also keeps track of and handles any user initiated input at this stage, for example, but not limited to, mouse clicks to acknowledge the viewing of the advertisement, and/or clicks on an a icon button for coupon.

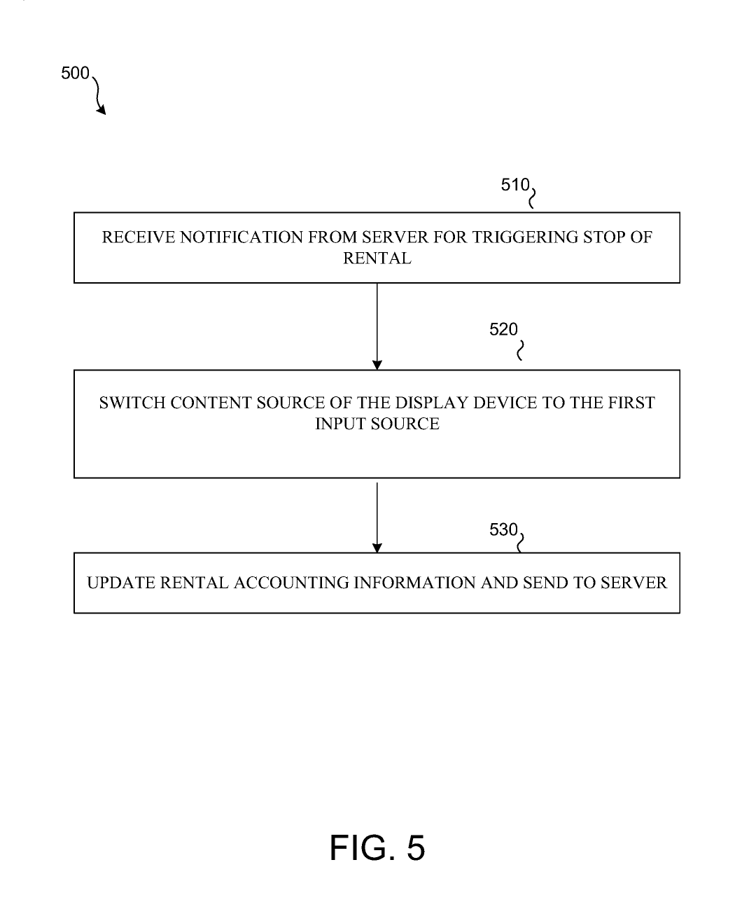

FIG. 5 illustrates further functionality of input selection device 110 to implement methods specifically pertaining to stopping serving of alternate ad at the end of rental interval, and updating of rental information. Input selection device 110 receives notification from server 140 in step 510. Input selection device 110 can receive the notification in procedures it executes and use that notification to implement methods in accordance with the embodiments of present invention. When it receives such notification in step 510 it makes content provider 130 as the source for display 120. Step 430 for example, includes but not limited to execution of programs that send CEC-HDMI commands to CEC-enabled display 120. The user then resumes viewing content through the first source. Step 520 also includes updating of rental accounting information, including but not limited to time of stop of rental.

Various embodiments of the present invention can be implemented in the form of logic in software or hardware or a combination of both. The logic may be stored in a computer readable or machine-readable non-transitory storage medium as a set of instructions adapted to direct a processor of a computer system to perform a set of steps disclosed in embodiments of the present invention. The logic may form part of a computer program product adapted to direct an information-processing device to perform a set of steps disclosed in embodiments of the present invention. Based on the disclosure and teachings provided herein, a person of ordinary skill in the art will appreciate other ways and/or methods to implement the present invention.

The above embodiments of the present invention are illustrative and not limiting. The above embodiments of the present invention may be combined, in one or multiple combinations, as various alternatives and equivalents are possible. Although, the invention has been described with reference to a display device as an example of an output device, it is understood that the invention is not limited by the type of output devices. Although, the invention has been described with reference to certain radio communications interface by way of an example, it is understood that the invention is not limited by the type of radio, wireless, or wired communications interface. Although, the invention has been described with reference to certain operating systems by way of an example, it is understood that the invention is not limited by the type of operating systems. Other additions, subtractions, or modifications are obvious in view of the present disclosure and are intended to fall within the scope of the appended claims.

What is claimed is:

1. A method for providing an information selection service by a server connected with an input selection device via a network, the input selection device connected with a first input of the display device, a second input of the display device connected with a content provider device, an output of the display device configured to be selected from the input selection device via the first input or the content provider device via the second input, the method including, by the server:
determining a switching period defining a period of time when output of the display device is selected from the input selection device via the first input;
detecting an arrival of the switching period while the output of the display device is selected from the content provider device via the second input; and
in response to detecting the arrival of the switching period, sending a trigger to the input selection device via the network to initiate the switching period such that the output of the display device switches from the second input connected with the content provider device to the first input connected with the input selection.

2. The method of claim 1 further comprising, by the server:
determining a plurality of parameters corresponding to user preferences received from the input selection device via the network;
selecting one or more sources of information according to the user preferences; and
subsequent to sending the trigger to the input selection device, providing the one or more sources of information to the input selection device via the network to facilitate output of the one or more sources of information on display device via the first input when the switching period is initiated.

3. The method of claim 2, wherein the plurality of parameters comprise one or more time intervals during which information can be presented to the user.

4. The method of claim 2, wherein the one or more sources of information comprise one or more advertisements.

5. The method of claim 4, wherein the plurality of parameters comprise:
one or more preferred advertisement tags that are used to select the one or more advertisements.

6. The method of claim 4, wherein the plurality of parameters comprise:
one or more compensation values corresponding to each viewed advertisement.

7. The method of claim 2, further comprising generating accounting information corresponding to the one or more advertisements provided to the output of the display device during the switching period.

8. The method of claim 1, further comprising, in response to detecting arrival of the switching period, and by the server:
determining whether the display device is in an ON state; and
sending the trigger to the input device in response to determining that the display device is in the ON state.

9. The method of claim 1, further comprising, by the server:
detecting an end of the switching period while the output of the display device is selected from the input selection device via the first input; and
in response to detecting the end of the switching period, sending a second trigger to the input selection device to end the switching period.

10. The method of claim 1, wherein the display device is a television.

11. The method of claim 1, wherein the arrival of the switching period corresponds with an arrival of a commercial period within content provided from the content provider device via the second input and an end of the switching period corresponds with an end of the commercial period within the content.

12. A system for providing an information selection service by a server connected with an input selection device via a network, the input selection device connected with a first input of the display device, a second input of the display device connected with a content provider device, an output of the display device configured to be selected from the input selection device via the first input or the content provider device via the second input, the system comprising:
the server configured to:
determine a switching period defining a period of time when output of the display device is selected from the input selection device via the first input;
detect an arrival of the switching period while the output of the display device is selected from the content provider device via the second input; and
in response to detecting the arrival of the switching period, send a trigger to the input selection device via the network to initiate the switching period such that the output of the display device switches from the second input connected with the content provider device to the first input connected with the input selection.

13. The system of claim 12, wherein the server is further configured to:
determine a plurality of parameters corresponding to user preferences received from the input selection device via the network;
select one or more sources of information according to the user preferences; and
subsequent to sending the trigger to the input selection device, provide the one or more sources of information to the input selection device via the network to facilitate output of the one or more sources of information on display device via the first input when the switching period is initiated.

14. The system of claim 13, wherein the plurality of parameters comprise one or more time intervals during which information can be presented to the user.

15. The system of claim 13, wherein the one or more sources of information comprise one or more advertisements.

16. The system of claim 15, wherein the plurality of parameters comprise:
one or more preferred advertisement tags that are used to select the one or more advertisements.

17. The system of claim 15, wherein the plurality of parameters comprise:
one or more compensation values corresponding to each viewed advertisement.

18. The system of claim 13, wherein the server is further configured to generate accounting information corresponding to the one or more advertisements provided to the output of the display device during the switching period.

19. The system of claim 12, wherein the server is further configured to, in response to detecting arrival of the switching period:
determine whether the display device is in an ON state; and
send the trigger to the input device in response to determining that the display device is in the ON state.

20. The system of claim 12, wherein the server is further configured to:
detect an end of the switching period while the output of the display device is selected from the input selection device via the first input; and
in response to detecting the end of the switching period, send a second trigger to the input selection device to end the switching period.

21. The system of claim 12, wherein the display device is a television.

22. The system of claim 12, wherein the arrival of the switching period corresponds with an arrival of a commercial period within content provided from the content provider device via the second input and an end of the switching period corresponds with an end of the commercial period within the content.
